(19) United States
(12) Patent Application Publication
(10) Pub. No.: US 2004/0174124 A1
(43) Pub. Date: Sep. 9, 2004

(54) Motor control method and system for parallel hybrid electric vehicle

(76) Inventor: Jae Wang Lee, Hwaseong-city (KR)

Correspondence Address: MORGAN, LEWIS & BOCKIUS, LLP., 3300 HILLVIEW AVENUE, PALO ALTO, CA, 94304, US

(21) Appl. No.: 10/705,559

(22) Filed: Nov. 10, 2003

(30) Foreign Application Priority Data
Mar. 5, 2003 (KR) 10-2003-0013602

(51) Int. Cl. H02P 5/00

(52) U.S. Cl. 318/139; 318/268

(57) ABSTRACT

A motor control method and a motor control system are provided which control a motor using an acceleration command and an estimated inertia moment of a motor. The motor control method for a parallel hybrid electric vehicle according to the preferred embodiment of the present invention comprises calculating an estimated inertia moment of a motor, calculating a forward compensation current based on the estimated inertia moment and an acceleration command, calculating a final current command based on a speed controller output current and the forward compensation current, the speed controller output current being calculated based on the acceleration command, and controlling the motor using the final current command.

### CROSS-REFERENCE TO RELATED APPLICATIONS

This application claims priority of Korean Application No. 10-2003-0013602, filed on Mar. 5, 2003, the disclosure of which is incorporated fully herein by reference.

### FIELD OF THE INVENTION

The present invention relates to a motor control method and a system thereof for a parallel hybrid electric vehicle, and more particularly, to a motor control method and a system thereof in which revolution speed of the motor is controlled based on an estimated inertia moment of the motor and an acceleration speed command.

### BACKGROUND OF THE INVENTION

In a parallel hybrid electric vehicle having a 4-cylinder 4-stroke engine, each piston experiences four strokes, that is, an intake stroke, a compression stroke, a power stroke, and an exhaust stroke. Each cylinder has a specific torque profile.

During the compression stroke, a negative torque with a magnitude of several times the average torque is generated, and during the power stroke, a positive torque with a magnitude of several tens of times the average torque is generated. The torque profiles in each of the four cylinders are the same, at a phase difference of 180 crankshaft degrees. The final output of the engine, which can be obtained by summing the torque profiles in the four cylinders, has a substantial torque ripple that cannot be negligible when compared to the average torque. Such torque ripple may cause a change in the rotational speed of a crankshaft, and it ultimately causes NVH (Noise, Vibration, and Harshness) characteristics.

In a parallel hybrid electric vehicle, a start motor that is coupled to a crankshaft of an engine is controlled to generate a counter torque against the torque ripple that is generated by an engine during engine start, so that the start period can be decreased and engine start can be performed more smoothly. If torque ripple is estimated based on engine speed change and the counter torque having an opposite phase to the torque ripple, the desired object to decrease the torque ripple can be obtained.

However, it is difficult to supply the counter torque with exact timing, and therefore there is a problem in that the torque ripple can be substantially increased by supplying the counter torque with wrong timing. If such torque ripple cannot be effectively decreased, there may be a large engine speed overshoot during engine start.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a motor control method and a motor control system for controlling a motor using a current signal that is calculated based on an acceleration command and an estimated inertia moment of the motor, thereby effectively decreasing engine torque ripple.

A motor control method for a parallel hybrid electric vehicle according to a preferred embodiment of the present invention comprises calculating an estimated inertia moment Ĵ_{eq} of a motor; calculating a forward compensation current i_{q-FF} based on the estimated inertia moment Ĵ_{eq} and an acceleration command a*; calculating a final current command i_{qs}* based on a speed controller output current i_{q-PI} and the forward compensation current i_{q-FF}, the speed controller output current i_{q-PI} being calculated based on the acceleration command a*; and controlling the motor using the final current command i_{qs}*.

It is preferable that the estimated inertial moment Ĵ_{eq} is calculated according to the following equation:

$${\hat{J}}_{eq} = \frac{1}{1 + τ s} \times \frac{{T}_{e}}{ⅆ {ω}_{m} / ⅆ t}$$

where τ is a time constant, Tₑ is a motor torque, and ωₘ is a motor speed.

It is further preferable that the forward compensation current i_{q-FF} is calculated according to the following equation:

$${i}_{q - FF} = {a}^{*} \times \frac{{\hat{J}}_{eq}}{{K}_{T}}$$

where a* is an acceleration command, Ĵ_{eq} is the estimated inertia moment, and K_{T} is a motor torque constant.

Preferably, the final current command i_{qs}* is calculated by summing the speed controller output current i_{q-PI} and the forward compensation current i_{q-FF}.

It is preferable that the speed controller output current i_{q-PI} is calculated using a difference between a speed command ωₘ* that is calculated based on the acceleration command a* and a motor speed ωₘ.

A motor control system for a parallel hybrid electric vehicle according to the preferred embodiment of the present invention comprises a motor that is directly coupled to an engine of the parallel hybrid electric vehicle, and a motor control unit controlling the motor. The motor control unit calculates an estimated inertial moment Ĵ_{eq} of the motor, and calculates a current command i_{qs}* for controlling the motor based on the estimated inertia moment Ĵ_{eq} and an acceleration command a*.

It is preferable that the estimated inertia moment Ĵ_{eq} is calculated with the following equation:

$${\hat{J}}_{eq} = \frac{1}{1 + τ s} \times \frac{{T}_{e}}{ⅆ {ω}_{m} / ⅆ t}$$

where τ is a time constant, Tₑ is a motor torque, and ωₘ is a motor speed.

Preferably, the current command i_{qs}* is calculated by summing a forward compensation current i_{q-FF} and a speed controller output current i_{q-PI}, the forward compensation current i_{q-FF} being calculated based on the estimated inertia moment Ĵ_{eq} and the acceleration command a*, the speed controller output current i_{q-PI} being calculated based on a difference between a speed command and a current motor speed.

It is preferable that the forward compensation current is calculated with the following equation:

$${i}_{q - FF} = {a}^{*} \times \frac{{\hat{J}}_{eq}}{{K}_{T}}$$

where a* is an acceleration command, Ĵ_{eq} is the estimated inertia moment, and K_{T} is a motor torque constant.

It is further preferable that the speed controller output current i_{q-PI} is calculated using a difference between a speed command ωₘ* that is calculated based on the acceleration command a* and a motor speed ωₘ.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a block diagram of a motor control system for a hybrid vehicle according to a preferred embodiment of the present invention;

FIG. 2 shows an algorithm for a motor control method for a hybrid vehicle according to a preferred embodiment of the present invention;

FIG. 3 is a flowchart of a motor control method for a hybrid vehicle according to the preferred embodiment of the present invention; and

FIG. 4A is a graph showing an engine speed profile according to a prior motor control method, and FIG. 4B is a graph showing an engine speed profile according to the motor control method according to a preferred embodiment of the present invention.

### DETAILED DESCRIPTION OF THE PREFERRED EMBODIMENTS

Hereinafter, a preferred embodiment of the present invention will be described in detail with reference to the accompanying drawings.

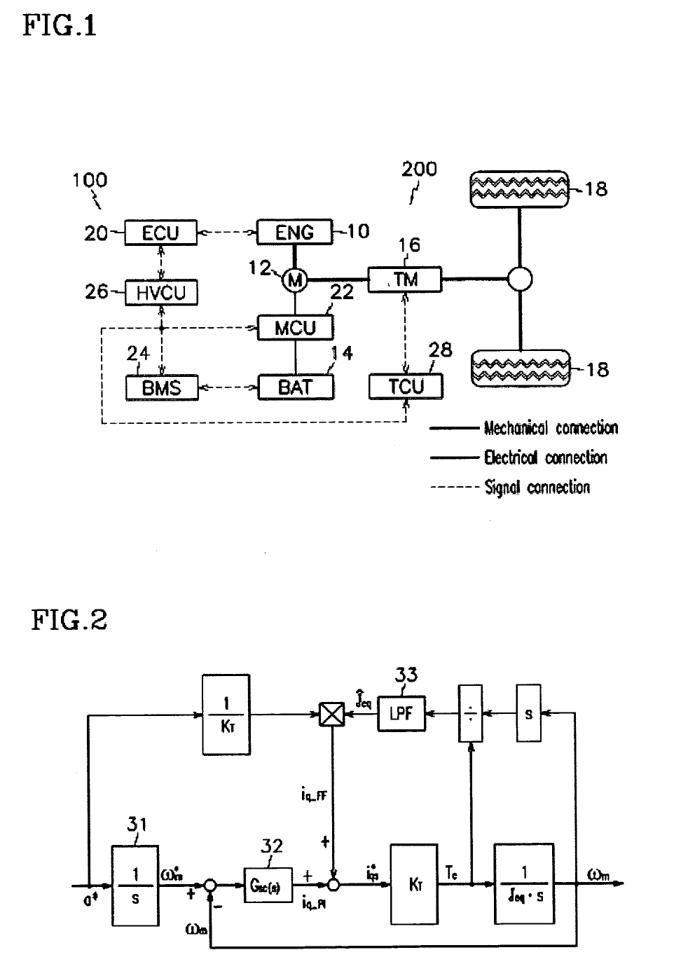

As shown in FIG. 1, a power system 100 of a parallel hybrid electric vehicle 200 includes an engine 10 and a motor 12, which respectively generate power for driving the vehicle. The engine 10 converts chemical energy of fuel to mechanical energy through combustion of the fuel, and the motor 12 generates mechanical energy using electrical energy of a battery 14. Rotational movement generated by the engine 10 and/or the motor 12 is shifted to a desired speed by a transmission 16, and the shifted rotational movement is transmitted to wheels 18, thereby driving the vehicle.

The power system 100 of the parallel hybrid electric vehicle 200 includes a plurality of control units such as an engine control unit (ECU) 20 for controlling the engine 10, a motor control unit (MCU) 22 for controlling the motor 12, a battery management system (BMS) 24 for controlling operations of the battery 14, a hybrid vehicle control unit (HVCU) 26, and a transmission control unit (TCU) 28 for controlling the transmission 16.

Each control unit preferably includes a processor, a memory, and other necessary hardware and software components as will be understood by persons skilled in the art, to permit the control units to execute the control functions as described herein.

It is preferable that the motor control method according to the preferred embodiment of the present invention is performed by the motor control unit 22. However, it is also possible that the motor control method is performed by the hybrid vehicle control unit 26.

The motor control method for the hybrid electric vehicle according to the present invention is based on an inertia estimation and an acceleration command. FIG. 2 shows a preferred algorithm for controlling the motor 12, and the algorithm may preferably be performed by the MCU 22.

The MCU 22 calculates a forward compensation current i_{q-FF} based on a given acceleration command a* and an estimated motor inertia moment Ĵ_{eq}.

The MCU 22 calculates a speed command ωₘ* from the acceleration command a* using an integrator (1/s) 31.

A proportional-integral (PI) speed controller 32 is supplied with the speed command ωₘ* and an actual speed ωₘ, and generates a speed controller output current i_{q-PI} using a difference between the speed command ωₘ* and the actual motor speed ωₘ.

The gain G_{SC} of the PI speed controller 32 can be determined as a function of a motor inertia moment, a motor torque constant, and the like. The gain of the PI speed controller 32 can be determined with the following equation 1.

$${G}_{sc} ( s ) = {K}_{p s} + \frac{{K}_{is}}{s} \qquad [ Equation 1 ]$$

where Kₚₛ is a proportional gain (P gain) of the PI speed controller 32, and Kᵢₛ is an integral gain (I gain) of the PI speed controller 32.

The proportional gain and the integral gain can be as follows.

$${K}_{p s} = \frac{{J}_{eq} {ω}_{sc}}{{K}_{T}} ,$$

and

Kᵢₛ=Kₚₛωₚᵢ

where ω_{sc} is a bandwidth of a control frequency of the PI speed controller 32, and ωₚᵢ is a cut-off frequency of the PI speed controller.

If ω_{sc} becomes greater, the gain of the PI speed controller becomes greater, and thereby response characteristics improve. However, the gain of the PI speed controller is generally restricted by system characteristics. That is, if the ω_{sc} is set as an excessively large value, the system may diverge.

A control period of the PI speed controller can preferably be set at 2 msec, but it is not restricted to this value.

It is evident in the art that the PI speed controller 32 generates the speed controller output current i_{q-PI} using the difference between the speed command ωₘ* and the actual speed or ωₘ. Accordingly, a further explanation for this will be omitted.

As shown in the following equation 2, the final current command i_{qs}* is calculated by summing the forward compensation current i_{q-FF} and the speed controller output current i_{q-PI}.

i_{qs}*=i_{q-PI}+i_{q-FF} [Equation 2]

The forward compensation current is calculated with the following equation 4 using a motor torque equation and with the following equation 3, which is a system equation.

$$\begin{matrix}{T}_{e} = {K}_{T} \times {i}_{qs}^{*} = {J}_{eq} \times \frac{ⅆ {ω}_{m}}{ⅆ t} & [ Equation 3 ] \\ {i}_{q - FF} = {a}^{*} \times \frac{{\hat{J}}_{eq}}{{K}_{T}} & [ Equation 4 ]\end{matrix}$$

where Tₑ is a motor torque, J_{eq} is a motor inertia moment, Ĵ_{eq} is an estimated motor inertia moment, K_{T} is a motor torque constant, and a* is an acceleration command.

When the vehicle is in a stationary state, a clutch of a transmission is in a disengaged state. Therefore, the inertia of the driving system is mainly composed of the inertias of a rotating member of the motor 12 and engine flywheel. In addition, it is assumed that friction between various bearings and friction between the cylinder block and pistons is negligible when compared to the inertia component.

In order to calculate the forward compensation current i_{q-FF} using the equation 4, the acceleration command a*, the estimated motor inertia moment Ĵ_{eq}, and the motor torque constant K_{T} are needed. The acceleration command a* and the motor torque constant K_{T} are given values, and the estimated motor inertia moment Ĵ_{eq} can be obtained by the following equation 5.

$${\hat{J}}_{eq} = \frac{1}{1 + τ s} \times \frac{{T}_{e}}{ⅆ {ω}_{m} / ⅆ t} \qquad [ Equation 5 ]$$

where τ is a time constant of a low pass filter (LPF) 33.

The low pass filter 33 is used in order to eliminate a high frequency noise component involved in a signal in the calculation of the estimated motor inertia moment Ĵ_{eq}. The low pass filter causes a time delay of an output signal with respect to an input signal. However, the effect of the time delay of the output signal caused by the low pass filter can be neglected, because a variation of the inertia according to time is not so great because of system characteristics.

The forward compensation current i_{q-FF} can be calculated by inputting the estimated inertia moment Ĵ_{eq} calculated with the equation 4 into the equation 5. Then, by inputting the calculated forward compensation current i_{q-FF} into the equation 2, the final current command i_{qs}* can be calculated.

The motor 12 is controlled using the calculated final current command i_{qs}*, and thereby the engine torque ripple can be effectively decreased.

The motor control method according to the preferred embodiment of the present invention precisely estimates the motor inertia moment using the characteristic that torque ripple is caused by an instantaneous change of the motor inertia moment, and instantaneously changes the forward compensation current.

If the torque ripple increases, the estimated inertia moment proportionally increases, so that the forward compensation current, which is added to the output of the proportional-integral speed controller, also increases.

Therefore, the speed change due to the torque ripple is decreased, so that the speed response characteristic is improved.

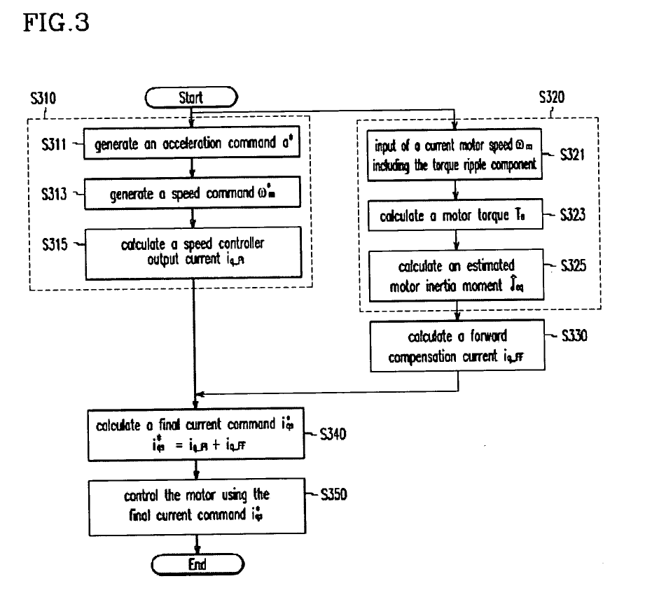

Referring to FIG. 3, the method for controlling the motor of the parallel hybrid electric vehicle will be explained. First, in step S310, the MCU 22 calculates the speed controller output current i_{q-PI}. For the calculation of the speed controller output current i_{q-PI}, the MCU 22 generates the acceleration command a* and the speed command ωₘ* in steps S311 and S313. Then, in step S315, the proportional-integral speed controller 32 calculates the speed controller output current i_{q-PI} using a difference between the speed command ωₘ* and the actual speed ωₘ as an input.

The MCU 22 calculates the estimated inertia moment Ĵ_{eq} in step S320, and, in step S330, calculates forward compensation current i_{q-FF} on the basis of the calculated estimated inertia moment Ĵ_{eq}.

In order to calculate the estimated inertia moment Ĵ_{eq}, in step S321, the MCU 22 is supplied with the motor speed ωₘ including the torque ripple component, and the motor torque Tₑ is calculated in step S323. Then, the MCU 22 calculates the estimated inertia moment Ĵ_{eq} using the motor torque Tₑ and the motor speed ωₘ.

The MCU 22, in step S330, calculates the forward compensation current i_{q-FF} on the basis of the estimated inertia moment Ĵ_{eq} and the acceleration command a*.

Then, in step S340, the MCU 22 calculates the final current command i_{qs}* by summing the speed controller output current i_{q-PI} and the forward compensation current i_{q-FF}, and the MCU 22 controls the motor using the final current command i_{qs}* in step S350.

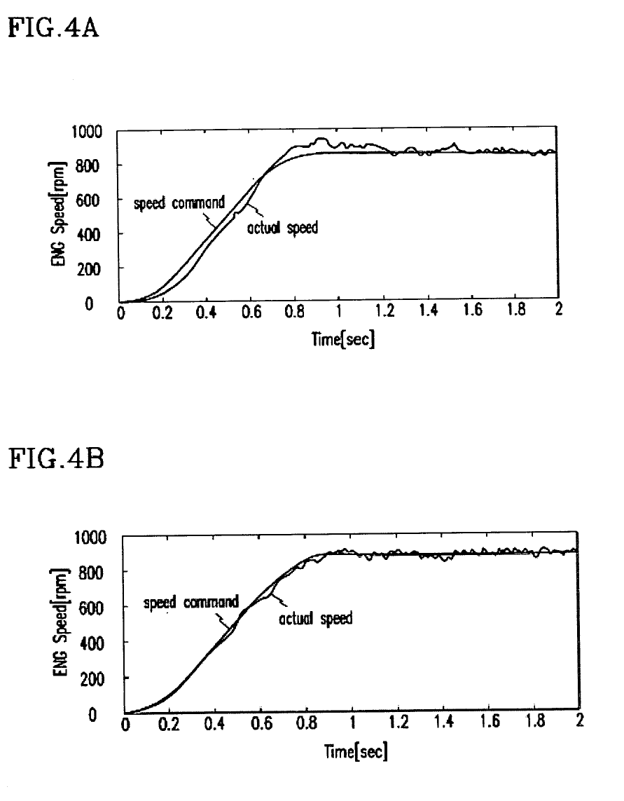

FIG. 4B shows an engine speed change when the motor control method according to the preferred embodiment of the present invention is applied, and it shows that the actual engine speed approaches the speed command. Compared with an engine speed according to a motor control method of the prior art, the motor control method can decrease start time (time period for the engine speed to reach an idle speed), and it can decrease an overshoot, so that speed response characteristics are also improved.

Such improvement of the speed response characteristics may decrease a speed change caused by engine torque ripple, so that NVH characteristics may also be improved.

The motor control method and the motor control system according to the preferred embodiment of the present invention controls the motor using the forward compensation current that is calculated based on the estimated motor inertia moment and the acceleration command, so that the engine torque ripple can effectively be decreased. Therefore, an overshoot of an engine speed during engine start can be decreased, improving the speed response characteristics.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A motor control method for a parallel hybrid electric vehicle, comprising;
calculating an estimated inertia moment of a motor;
calculating a forward compensation current based on the estimated inertia moment and an acceleration command;
calculating a final current command based on a speed controller output current and the forward compensation current the speed controller output current being calculated based on the acceleration command; and
controlling the motor using the final current command.

2. The motor control method of claim 1, wherein the estimated inertia moment Ĵ_{eq} is calculated with the following equation:
$${\hat{J}}_{eq} = \frac{1}{1 + τ s} \times \frac{{T}_{e}}{ⅆ {ω}_{m} / ⅆ t}$$
where τ is a time constant, Tₑ is a motor torque, and ωₘ is a motor speed.

3. The motor control method of claim 1, wherein the forward compensation current i_{q-FF} is calculated with the following equation:
$${i}_{q - FF} = {a}^{*} \times \frac{{\hat{J}}_{eq}}{{K}_{T}}$$
where a* is an acceleration command, Ĵ_{eq} is the estimated inertia moment, and K_{T} is a motor torque constant.

4. The motor control method of claim 1, wherein the final current command is calculated by summing the speed controller output current and the forward compensation current.

5. The motor control method of claim 1, wherein the speed controller output current is a difference between a speed command that is calculated based on the acceleration command a* and a motor speed.

6. A motor control system for a parallel hybrid electric vehicle comprising:
a motor that is directly coupled to an engine of the parallel hybrid electric vehicle; and
a motor control unit controlling the motor,
wherein the motor control unit calculates an estimated inertia moment of the motor, and calculates a current command for controlling the motor based on the estimated inertia moment and an acceleration command.

7. The motor control system of claim 6, wherein the estimated inertia moment Ĵ_{eq} is calculated with the following equation:
$${\hat{J}}_{eq} = \frac{1}{1 + τ s} \times \frac{{T}_{e}}{ⅆ {ω}_{m} / ⅆ t}$$
where τ is a time constant, Tₑ is a motor torque, and ωₘ is a motor speed.

8. The motor control system of claim 6, wherein the current command i_{qs}* is calculated by summing a forward compensation current i_{q-FF} and a speed controller output current i_{q-PI}, the forward compensation current i_{q-FF} being calculated based on the estimated inertia moment Ĵ_{eq} and the acceleration command a*, the speed controller output current i_{q-PI} being calculated based on a difference between a speed command and a current motor speed.

9. The motor control system of claim 8, wherein the forward compensation current is calculated with the following equation:
$${i}_{q - FF} = {a}^{*} \times \frac{{\hat{J}}_{eq}}{{K}_{T}}$$
where a* is an acceleration command, Ĵ_{eq} is the estimated inertia moment, and K_{T} is a motor torque constant.

10. The motor control system of claim 8, wherein the speed controller output current i_{q-PI} is a difference between a speed command ωₘ* that is calculated based on the acceleration command a*, and a motor speed ωₘ.
